(19) United States
(12) Patent Application Publication
(10) Pub. No.: US 2026/0299247 A1
(43) Pub. Date: Oct. 1, 2026

(54) INTELLIGENT HEAD MIRROR

(71) Applicants: Gentex Corporation, Zeeland, MI (US); Mayo Foundation for Medical Education and Research, Rochester, MN (US)

(72) Inventors: Brock R. Rycenga, Wyoming, MI (US); David M. Bostrom, Zeeland, MI (US)

(21) Appl. No.: 19/630,004

(22) Filed: Mar. 26, 2026

Related U.S. Application Data
(60) Provisional application No. 63/777,815, filed on Mar. 26, 2025.

(51) Int. Cl. G02B 7/00; G02B 7/182

(52) U.S. Cl. CPC G02B 7/002; G02B 7/182

(57) ABSTRACT

An intelligent head mirror including a head strap, a first light directing device pivotally coupled to the head strap, wherein the first light directing device redirects light toward a focal point, and an electrical actuator operably coupled to the first light directing device, wherein the electrical actuator is configured to pivot the first light directing device relative to the head strap in at least two dimensions.

### CROSS-REFERENCE TO RELATED APPLICATION

This application claims priority to and the benefit under 35 U.S.C. § 119(e) of U.S. Provisional Application No. 63/777,815, filed on Mar. 26, 2025, entitled “INTELLIGENT HEAD MIRROR,” the disclosure of which is hereby incorporated herein by reference in its entirety.

### FIELD OF THE DISCLOSURE

The present disclosure generally relates to lighting systems, and more specifically to head-mounted light directing devices.

### SUMMARY OF THE DISCLOSURE

According to one aspect of the present disclosure, an intelligent head mirror includes a head strap, a first light directing device pivotally coupled to the head strap, wherein the first light directing device is configured to redirect light toward a focal point, and an electrical actuator operably coupled to the first light directing device, wherein the electrical actuator is configured to pivot the first light directing device relative to the head strap in at least two dimensions.

According to another aspect of the present disclosure, an intelligent lighting system includes an intelligent head mirror having a head strap and a light directing device with a reflective surface, wherein the light directing device is coupled to the head strap, and wherein the light directing device is pivotal relative to the head strap in at least two dimensions. A sensor is disposed on the intelligent head mirror, wherein the sensor detects an instant disposition of the light directing device relative to a reference disposition, and a controller is in communication with the intelligent head mirror, wherein the controller receives instant disposition data from the sensor and controls an orientation of the light directing device relative to the head strap.

According to yet another aspect of the present disclosure, an intelligent head mirror includes a head strap, a first light directing device pivotally coupled to the head strap, wherein the first light directing device is configured to redirect light toward a focal point, an electrical actuator operably coupled to the first light directing device, wherein the electrical actuator is configured to pivot the first light directing device relative to the head strap, and a battery pack electrically coupled to the electrical actuator, wherein the battery pack is configured to power the electrical actuator.

Tethered wearable headlights worn by users for diminishing shadows proximate an operating location during a medical procedure have a limited range and restrict the mobility of users within such limited range. On the other hand, wearable headlights that are not tethered and instead are battery powered are unable to provide adequate lighting for a duration required for various lengthy medical procedures. In addition, known medical headlight devices for medical operations are heavy and can trap heat generated by users, increasing the risk of muscle strain and undesirable heat buildup, respectively. These medical headlight devices may therefore result in uncomfortable conditions for users (e.g., surgeons) relying on such medical headlight devices for extended periods of time. The intelligent head mirror disclosed herein offers an improved, lighter light-directing solution for various conditions, such as extensive operations and deep-cavity use cases that require optimal lighting for extended periods, for example. The intelligent head mirror may operate without a light source attached thereto, thus requiring minimal electronics and less power input, providing for a reduced load carried by a user, and decreasing heat entrapment generated by a user while wearing the intelligent head mirror. Additionally, the reduced power drawn by the intelligent head mirror provides an opportunity for detethering the intelligent head mirror from an external power source. Accordingly, the intelligent head mirror may be portable and may include an independent power source for increased mobility.

The intelligent head mirror disclosed herein is also advantageous over head mirrors known in the art. Head mirrors are known to include one manually adjustable mirror, requiring users to adjust the disposition of the mirror by hand. Such manual adjustability is less precise than a user may prefer and is cumbersome, especially when light units, a user, and/or a target area to be illuminated change location and/or orientation. As described herein, the intelligent head mirror provides for electrically actuated adjustment of a light directing device for more convenient control of the light directing device. The electrically actuated adjustment of the light directing device may be controlled by the user or, alternatively, automatically adjust based on factors including but not limited to the orientation and/or location of the light units, the user, the light directing device, and a target area to be illuminated. The intelligent head mirror may additionally include more than one light directing device to promote further shadow mitigation.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is an upper side perspective view of an intelligent head mirror directing light toward a target area;

FIG. 2 is a side schematic view of a surgical suite equipped with an intelligent lighting system, the intelligent lighting system including an overhead light unit, a table light unit coupled to an operating table, and the intelligent head mirror coupled to a head of a user; and

FIG. 3 is a top view of the operating table provided in the surgical suite of FIG. 2, the operating table supporting a patient, where the intelligent lighting system has identified a target area to be illuminated.

### DETAILED DESCRIPTION

The present illustrated embodiments reside primarily in combinations of method steps and apparatus components related to an intelligent head mirror. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

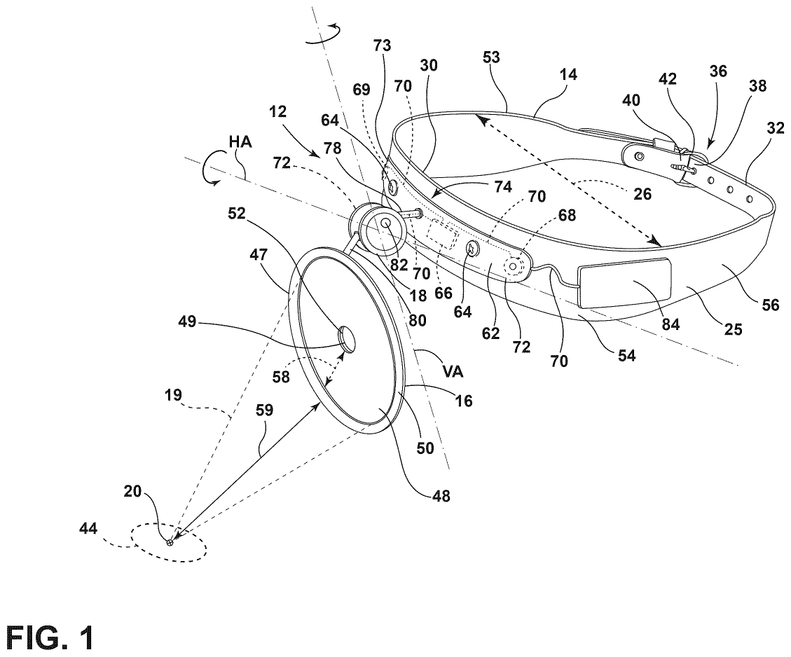

For purposes of description herein, the terms “upper,” “lower,” “right,” “left,” “rear,” “front,” “vertical,” “horizontal,” and derivatives thereof, shall relate to the disclosure as oriented in FIG. 1. Unless stated otherwise, the term “front” shall refer to a surface of the device closest to an intended viewer, and the term “rear” shall refer to a surface of the device furthest from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

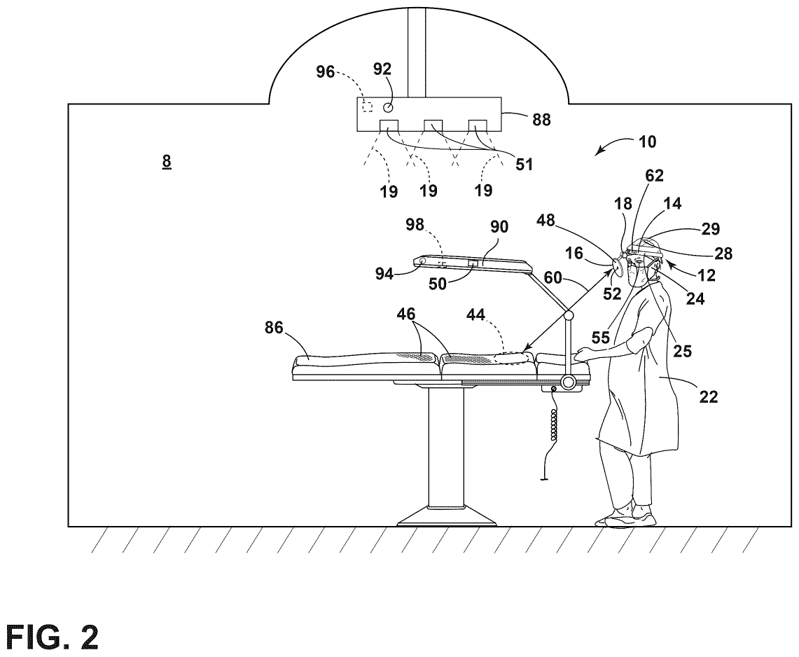

Referring initially to FIGS. 1 and 2, a surgical suite 8 is equipped with an intelligent lighting system 10. The intelligent lighting system 10 includes an intelligent head mirror 12 having a head strap 14, a light directing device 16, and an electrical actuator 18. The light directing device 16 is pivotally coupled to the head strap 14 and is configured to redirect light 19 toward a focal point 20. The electrical actuator 18 is operably coupled to the light directing device 16 and is configured to pivot the light directing device 16 relative to the head strap 14.

According to various implementations, the head strap 14 of the intelligent head mirror 12 is configured to be secured to a user 22, and particularly, to a head 24 of the user 22. As demonstrated in FIGS. 1 and 2, the head strap 14 may include a loop or band 25 with an approximate diameter 26 and may be selectively constricted around at least a portion of the head 24 of the user 22. According to one example, the band 25 may be secured to the head 24 of the user 22 such that the band 25 extends along a substantially lateral perimeter of the head 24. Here, the band 25 may define a front side 30 of the head strap 14 and a rear side 32 of the head strap 14. The head strap 14 may additionally include a top strap 28 coupled to the band 25 at the front side 30 of the head strap 14 and the rear side 32 of the head strap 14. Accordingly, with the head strap 14 secured to the head 24 of the user 22, the top strap 28 may extend over a superior portion 29 of the head 24 between the front and rear sides 30, 32 (FIG. 2). It is also contemplated that the head strap 14 may form a head cap that, with the head strap 14 secured to the head 24 of the user 22, covers at least a portion of the head 24.

In some configurations, the head strap 14 may have an adjustment mechanism 36 configured to facilitate an adjustable securement of the head strap 14 to the head 24 of the user 22. Particularly, the adjustment mechanism 36 can adjust (e.g., increase or decrease) the approximate diameter 26 of the band 25 of the head strap 14. By way of example, the band 25 of the head strap 14 illustrated in FIG. 2 defines a first end 38 and a second end 40, where the first end 38 is adjustably coupled to the second end 40 via a buckle 42, allowing the user 22 to adjust the head strap 14. The adjustment mechanism 36 may additionally or alternatively include an adjustable hook-and-loop fastener arrangement, an elastic material integrated into the head strap 14, an adjustable snap tab arrangement, an adjustable sliding buckle, or a combination thereof, for example.

Referring still to FIGS. 1 and 2, the light directing device 16 of the intelligent head mirror 12 is operably coupled to the head strap 14 proximate the front side 30. According to various configurations, the light directing device 16 is configured to route light 19 toward a target area 44 to illuminate and diminish shadows 46 at the target area 44. As shown, the light directing device 16 has a circular perimeter 47, a reflective front surface 48, and a rear surface 49, where the reflective front surface 48 is configured to redirect light 19 from a light source 51 toward the target area 44. Here, a protective sleeve 50 may extend along the circular perimeter 47 of the light directing device 16. The light directing device 16 may define a center aperture 52 extending from the rear surface 49 to the reflective front surface 48 such that the user 22 can observe with one eye 55 the target area 44 through the center aperture 52, aiding against errors in visual perception of the user 22 resulting from parallax. Accordingly, the light directing device 16 may extend from an outer surface 54 of the head strap 14 proximate the front side 30 and may be situated inferior to the head strap 14 such that the center aperture 52 is alignable with one of a pair of eyes 55 of the user 22. According to some aspects, the light directing device 16 may have a wide variety of geometries (e.g., rectangular, elliptical, etc.) other than a circular geometry. Furthermore, the intelligent head mirror 12 may be configured to redirect solely ambient lighting or sunlight, provided in a particular room or location, toward the target area 44. It is contemplated that the light directing device 16 may be fixedly or adjustably coupled to the head strap 14 such that the electrical actuator 18 is omitted. In some configurations, the light directing device 16 may omit the center aperture 52.

According to various implementations, the light directing device 16 may be situated level to or superior to the head strap 14 to redirect light 19 from the light source 51 toward the target area 44. In some configurations, the intelligent head mirror 12 may include a plurality of light directing devices 16 that are each configured to route light 19 toward the target area 44 along a distinct light path to further illuminate and diminish shadows 46 at the target area 44. For example, the intelligent head mirror 12 may include one light directing device 16 extending from the outer surface 54 of the head strap 14 proximate the front side 30, a second light directing device 16 extending from a left side 53 of the head strap 14, and a third light directing device 16 extending from a right side 56 of the head strap 14. Each of the plurality of light directing devices 16 incorporated into the intelligent head mirror 12 may be fixedly coupled to the head strap 14 or operably coupled to the head strap 14. Accordingly, the intelligent head mirror 12 may include a plurality of electrical actuators 18. Here, each of the plurality of light directing devices 16 may be coupled to a distinct electrical actuator 18. According to various aspects, the plurality of light directing devices 16 may operate independently and may redirect light 19 toward a common target area 44 or distinct target areas 44, for example.

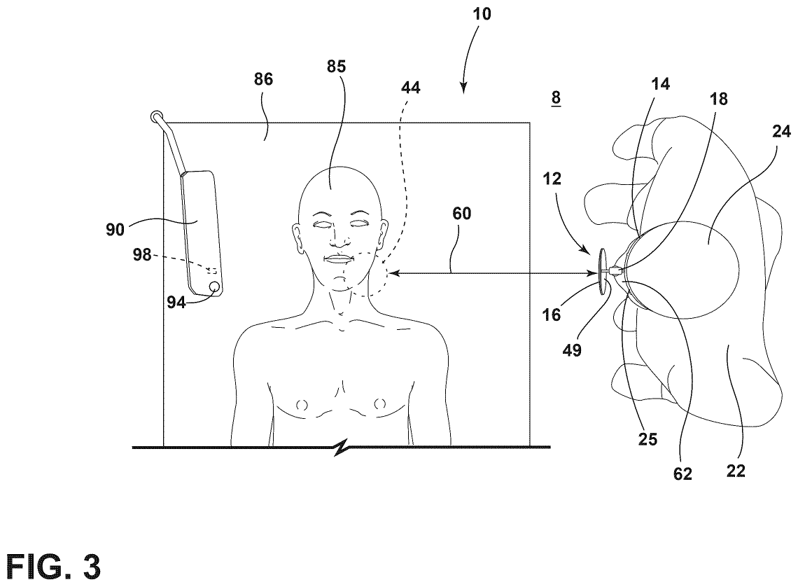

Regarding the intelligent head mirror 12 illustrated in FIG. 1, the front surface 48 of the light directing device 16 may be at least partially reflective, and light 19 originating anterior to the light directing device 16 may accordingly be at least partially reflected by the front surface 48. The front surface 48 may additionally be parabolically curved. As a result, light 19 reflected by the front surface 48 may thereafter converge toward the focal point 20. It is contemplated that the parabolic curve of the front surface 48 of the illustrated light directing device 16 may be adjusted such that a gap 59 between the focal point 20 and the light directing device 16 is adjustable. The adjustability of the gap 59 between the focal point 20 and the light directing device 16 may increase the effectiveness of the intelligent head mirror 12 during a surgical operation and across various use cases. The front surface 48 of the light directing device 16 may alternatively define or form a different type of curve as opposed to the parabolic curve in some instances. The rear surface 49 (FIG. 3) of the light directing device 16 may define a similar or different curve as compared to the front surface 48 to control the direction of light 19 originating posterior to the light directing device 16 toward the target area 44 as desired. In some configurations, the front surface 48 may be optically transmissive, and the rear surface 49 may be reflective.

According to various configurations, the light directing device 16 may refract light 19 toward the focal point 20, collimate light 19 toward the target area 44, or otherwise direct light 19 originating posterior to or elsewhere relative to the light directing device 16 toward the target area 44. According to one example, the light directing device 16 may include one or more fiber optic cables. Each of the one or more fiber optic cables may include a first portion or end coupled to the head strap 14 and a second portion or end coupled to the first end, where light 19 from the light source 51 can be received by the second end and transmitted to the first end. In such configurations, light 19 transmitted to the first end may then be directed or routed toward the target area 44 by the first end. Here, the light directing device 16 may additionally include a lens in communication with the first end of the fiber optic cable to further direct or route toward the target area 44 light 19 transmitted to the first end.

With further reference to FIGS. 1 and 2, the location of the focal point 20 relative to the light directing device 16 may depend, at least in part, on the curvature of the front surface 48. Furthermore, the intensity of light 19 at the focal point 20 may depend, at least in part, on a radius 58 of the light directing device 16, the reflectivity of the front surface 48, and the brightness of light 19 to which the front surface 48 is exposed. The curvature of the front surface 48, the radius 58 of the light directing device 16, the reflectivity of the front surface 48, and the brightness of light 19 to which the front surface 48 is exposed together are hereinafter referred to as light directing parameters. As such, the illumination of the target area 44 by light 19 routed thereto from the light directing device 16 is affected by the light directing parameters. According to some aspects, the illumination of the target area 44 by light 19 routed thereto from the light directing device 16 may further be affected by a distance 60 between the light directing device 16 and the target area 44 (FIG. 3), the orientation of the light directing device 16 relative to the target area 44, and the brightness, location, and orientation of the light sources 51 (together hereinafter referred to as “operating parameters”). According to some aspects, the focal point 20 of the light directing device 16 and the target area 44 may be aligned. In another aspect where the focal point 20 is located further from the light directing device 16 than the target area 44, the illumination of the target area 44 by light 19 routed thereto from the light directing device 16 may be less intense and more dispersed than the illumination of the target area 44 in an instance where the focal point 20 is located at the target area 44.

As demonstrated in FIG. 1, the intelligent head mirror 12 may additionally include an elongate bracket 62 coupled to the outer surface 54 of the head strap 14 proximate the front side 30. As shown, the elongate bracket 62 is coupled to the outer surface 54 via fasteners 64 such that the bracket 62 is configured to align with a forehead of the user 22 when the intelligent head mirror 12 is secured to the head 24 of the user 22. The light directing device 16 and the electrical actuator 18 are coupled to the bracket 62, while a controller 66, a first sensor 68, and a second sensor 69 are at least partially supported by the bracket 62. Here, the controller 66 (hereinafter “controller” or “first controller”) is in electrical communication with the first and second sensors 68, 69 via wiring 70. Alternatively, the electrical communication between the controller 66 and each of the first and second sensors 68, 69 may be wireless.

According to various implementations, the controller 66 of the intelligent head mirror 12 may include a memory and a processor. The memory may store computer executable commands, such as those disclosed in U.S. Pat. No. 10,925,140 (hereinafter “the '140 patent”), entitled “SYSTEMS AND METHODS FOR DETECTION AND ILLUMINATION OF REGIONS OF INTEREST,” issued on Feb. 16, 2021, to Hallack et al., the disclosure of which is hereby incorporated by reference herein in its entirety. The '140 patent also discloses an illumination system in a surgical suite, the illumination system providing for the control of light assemblies to alter, for example, an intensity, focus, and/or origin of light emitted from the light assemblies to illuminate shadows. The illumination system of the '140 patent also includes a wearable device having one or more imagers to collimate and/or focus light reflected by a patient, the table, or other features of the surgical suite. The teachings of the '140 patent are relevant to the present disclosure, as the intelligent lighting system 10 of the present disclosure may include or cooperate with the illumination system described therein. Furthermore, the intelligent head mirror 12 of the present disclosure may include one or more features of the wearable device disclosed in the '140 patent. Where inconsistencies or conflicts may arise between the teachings of the present disclosure and those of the '140 patent, the teachings of the present disclosure shall govern. Notably, however, the presence or absence of disclosures from the '140 patent in the present disclosure does not alone constitute an inconsistency between the teachings of the present disclosure and those of the '140 patent.

According to various implementations, the memory of the controller 66 may store computer executable commands such as those disclosed in U.S. Pat. No. 10,828,124 (hereinafter “the '124 patent”), entitled “ILLUMINATION SYSTEMS,” issued on Nov. 10, 2020, to Geerlings et al., the disclosure of which is hereby incorporated by reference herein in its entirety. The '124 patent discloses an illumination system integrated into a location such as a medical suite, the illumination system including a controller and various accessories that may be utilized in the medical suite to selectively illuminate a location or operating region. The teachings of the '124 patent are relevant to the present disclosure, as the intelligent lighting system 10 of the present disclosure may include or cooperate with the illumination system described therein. Furthermore, the intelligent head mirror 12 of the present disclosure may include one or more features of the wearable device disclosed in the '124 patent. Where inconsistencies or conflicts may arise between the teachings of the present disclosure and those of the '124 patent, the teachings of the present disclosure shall govern. Notably, however, the presence or absence of disclosures from the '124 patent in the present disclosure does not alone constitute an inconsistency between the teachings of the present disclosure and those of the '124 patent.

According to various implementations, the intelligent head mirror 12 may have a wide variety of configurations. For example, one or more of the controller 66, the first and second sensors 68, 69, and the wiring 70 may be disposed on or within the bracket 62. In some configurations, the bracket 62 may be disposed at a different location along the head strap 14, such as along the top strap 28, and may additionally or alternatively be integrally formed with and/or indistinct from the head strap 14. Accordingly, the light directing device 16, the electrical actuator 18, the controller 66, the first and second sensors 68, 69, and/or the wiring 70 may be coupled directly to the head strap 14 in some configurations. It is also contemplated that the first sensor 68, the second sensor 69, the controller 66, or a combination thereof may be omitted from the intelligent head mirror 12. In one example, the intelligent head mirror 12 may include only one of the first and second sensors 68, 69.

As illustrated in FIG. 1, the first sensor 68 of the intelligent head mirror 12 is disposed proximate a right end 72 of the bracket 62, and the second sensor 69 of the intelligent head mirror 12 is disposed proximate a left end 73 of the bracket 62. The first and second sensors 68, 69 may be configured to receive (e.g., measure, collect, etc.) input data to assist the controller 66 in determining a current orientation and/or position (hereinafter “instant disposition”) of the light directing device 16 within the surgical suite 8 (FIG. 2) and/or relative to the head strap 14. The input data received by the first and second sensors 68, 69 may further assist the controller 66 in determining an optimal orientation and/or position (hereinafter “target disposition”) of the light directing device 16 within the surgical suite 8 and/or relative to the head strap 14, where the light directing device 16 directs light 19 toward the target area 44 in the target disposition. According to some aspects, the instant disposition of the light directing device 16 represents a current angular position of the light directing device 16 relative to the head strap 14 of the intelligent head mirror 12, and the target disposition of the light directing device 16 represents the angular position of the light directing device 16 relative to the head strap 14 at which the light directing device 16 redirects light 19 toward the target area 44.

According to various implementations, the first and second sensors 68, 69 may be configured to receive the input data and then transmit the input data to the controller 66. The input data may be one or more of acceleration data of the intelligent head mirror 12, orientation and/or position data of the intelligent head mirror 12, orientation and/or position data of the light directing device 16 relative to the surgical suite 8 or another component of the intelligent head mirror 12, light exposure data, energy or power data, and image data, for example. Furthermore, the first and second sensors 68, 69 may receive the same or different input data. According to various aspects, the controller 66 may be configured to process the input data and determine the target disposition. In some configurations, the focal point 20 of the light directing device 16 may be located at or otherwise proximate the target area 44 with the light directing device 16 in the target disposition.

Referring still to FIG. 1, the light directing device 16 is coupled to an electrical actuator 18. As shown, the electrical actuator 18 is coupled to the bracket 62 at a midpoint 74 thereof. Here, the electrical actuator 18 includes a first arm 78 and a second arm 80 that is pivotal relative to the first arm 78. The first arm 78 is coupled to and extends outward from the bracket 62, and the second arm 80 is coupled to the light directing device 16. As a result, the light directing device 16 is pivotal relative to the head strap 14. The light directing device 16, as illustrated, is pivotal in two dimensions. Particularly, the light directing device 16 is pivotal about a horizontal axis HA and a vertical axis VA to optimally redirect light 19 provided by one or more light sources 51 (FIG. 2) toward the target area 44. According to various configurations, each of the horizontal axis HA and the vertical axis VA may extend through the electrical actuator 18 and/or the light directing device 16. In some instances, the light directing device 16 may be pivotal in more than two dimensions and/or about one or more axes other than the horizontal axis HA and the vertical axis VA. To achieve rotation in at least two dimensions, the intelligent head mirror 12 may have more than one electrical actuator 18. In other instances, to minimize the cost, weight, electronics, power draw, and/or controller processing power as required by the intelligent lighting system 10 (FIG. 2), the light directing device 16 of the intelligent head mirror 12 may be pivotal relative to the head strap 14 in only one dimension. The one or more electrical actuators 18 incorporated into the intelligent head mirror 12 may each have a wide variety of configurations, according to various aspects.

According to various implementations, the electrical actuator 18 is not limited to any particular type of actuator. For example, the electrical actuator 18 may include, but is not limited to, linear actuators, rotary actuators, spherical actuators, stepper motors, servo motors, solenoids, piezoelectric actuators, brushless DC motors, or a combination thereof. Each of these examples may be employed based on the specific requirements of the use case of the intelligent head mirror 12 relating to precision, speed, force output, and/or energy efficiency. The configuration of the electrical actuator 18 may depend on factors such as the size of the intelligent lighting system 10, the weight of the light directing device 16, the location of the light sources 51 of the intelligent lighting system 10 (FIG. 2), and the controller mechanisms used in the intelligent lighting system 10. It is understood that this disclosure encompasses all variations of electrical actuators including but not limited to those described herein.

With further reference to FIG. 1, the electrical actuator 18 may include a third sensor 82. As shown, the third sensor 82 is an angular position sensor. Accordingly, the third sensor 82 may receive angular position data of the light directing device 16 and transmit (through the wiring 70 or wirelessly) the received angular position data to the controller 66. The controller 66 may be configured to process the angular position data transmitted by the third sensor 82 and determine the current angular position of the light directing device 16 about the vertical axis VA and the horizontal axis HA relative to a reference angular position. The controller 66 may account for the current angular position when determining the instant disposition of the light directing device 16. The reference angular position may be established incrementally, during an initialization routine, or during a calibration routine, for example. It is also contemplated that the controller 66 may determine the instant disposition of the light directing device 16 without accounting for a reference angular position. In some configurations, the third sensor 82 may receive angular position data of the light directing device 16 about one or more distinct axes, in addition to or instead of the vertical axis VA and the horizontal axis HA, relative to the reference angular position, and the controller 66 may determine the current angular position of the light directing device 16 about these one or more distinct axes. According to some aspects, the electrical actuator 18 may include a plurality of angular position sensors that each receive angular position data of the light directing device 16 about a distinct and separate axis.

According to some aspects, the intelligent head mirror 12 may omit the third sensor 82, and the first sensor 68 and/or the second sensor 69 may instead perform the functions of the third sensor 82. Alternatively, the first sensor 68 and/or the second sensor 69 may be omitted by the intelligent head mirror 12, and the third sensor 82 may perform the functions of the first sensor 68 and/or the second sensor 69. It is also contemplated that the intelligent head mirror 12 may include only one of the first, second, and third sensors 68, 69, 82 or, alternatively, the intelligent lighting system 10 (FIG. 2) may include one or more sensors in addition to the first, second, and third sensors 68, 69, 82. In some configurations, the light directing device 16 may be linearly displaced in one or more dimensions relative to the head strap 14 during the operation of the light directing device 16 between dispositions. For example, the location and configuration of the electrical actuator 18, the addition of one or more linear actuators, and/or the dimensions of the first and second arms 78, 80 of the electrical actuator 18 may result in the linear displacement of the light directing device 16 during the operation of the light directing device 16 between dispositions. One or more of the first, second, and third sensors 68, 69, 82 may receive linear displacement data of the light directing device 16 in some instances, which may be taken into account by the controller 66 when determining the instant disposition of the light directing device 16.

Referring still to FIG. 1, the electrical actuator 18, the controller 66, and the first, second, and third sensors 68, 69, 82 are powered by a battery pack 84 disposed on the right side 56 of the head strap 14 at a location spaced from the right end 72 of the bracket 62. Here, the wiring 70 electrically couples the battery pack 84 to the controller 66, the electrical actuator 18, and the first, second, and third sensors 68, 69, 82. Accordingly, the intelligent head mirror 12 is portable about the surgical suite 8 (FIG. 2) and is untethered from external power sources. Alternatively, the intelligent head mirror 12 may include an alternative power source in addition to or instead of the battery pack 84. For example, the intelligent head mirror 12 may include a solar cell configured to operate the intelligent head mirror 12 via sunlight or artificial light. Furthermore, the intelligent head mirror 12 may be tethered to an external power source. Regarding configurations in which the intelligent head mirror 12 includes the battery pack 84, the battery pack 84 may be disposed in a location on the head strap 14 other than on the right side 56 of the head strap 14 at the location spaced from the right end 72 of the bracket 62 or may be separated from and in wired communication with the head strap 14.

According to various implementations, the controller 66 of the intelligent head mirror 12 may be disposed within the bracket 62. As shown in FIG. 1, the controller 66 is powered by the battery pack 84 and is in communication with the first, second, and third sensors 68, 69, 82. In some configurations, the controller 66 may be configured to receive data, such as input data, from the first, second, and third sensors 68, 69, 82; process the data received from the first, second, and third sensors 68, 69, 82; determine the instant disposition of the light directing device 16; determine a target disposition of the light directing device 16; compare the instant disposition to the target disposition; and activate the electrical actuator 18 in response to determining that the instant disposition is different than the target disposition. The controller 66 may determine the target disposition of the light directing device 16 after determining the location of the target area 44 based on user-inputted target area data or target area data received from the first, second, and/or third sensor 68, 69, 82, for example, as further described below.

With reference to FIGS. 1 and 2, the target disposition of the light directing device 16 may be determined by the user 22 or by the controller 66 via a light control routine or a shadow mitigation routine as described in the '140 patent, for example. The controller 66 may additionally or alternatively detect markers (e.g., instruments, a hand of the user 22, one or both of the eyes 55 of the user 22, a patient 85 (FIG. 3), an operating table 86, an RF tracker, a marker described in the '140 patent, a marker described in the 3 124 patent, etc.), which may affect the determination of the target disposition and/or the location of the target area 44. For example, the target disposition may be the orientation and/or location of the light directing device 16 such that the light 19 routed toward the target area 44 by the light directing device 16 is not obstructed by an instrument or a hand of the user 22.

According to various implementations, the target area 44 is a location to be illuminated by the intelligent lighting system 10. In some instances, the user 22 may control the location of the target area 44 as desired. For example, the target area 44 may be a location where the user 22 is looking or a location corresponding to data inputted by the user 22 into a user interface that is in communication, directly or indirectly, with the controller 66. Alternatively, the target area 44 to be illuminated may be determined by the controller 66. With data received by one or more of the first, second, and third sensors 68, 69, 82, the controller 66 may identify the markers and/or shadows 46 provided within a region of interest and determine the target area 44. The controller 66 may further identify a marked incision location, an open surgical incision, a specific body part, and/or an anatomical area on the patient 85 (FIG. 3), which may be determined by the controller 66 to be the target area 44. In other instances, the controller 66 may determine the target area 44 by executing stored computer executable commands, such as the light control routine of the '140 patent or the '124 patent, or the shadow mitigation routine as described in the '140 patent.

Referring to FIGS. 2 and 3, the surgical suite 8 is shown having the operating table 86 and a plurality of light units 88, 90. As illustrated, the plurality of light units 88, 90 includes an overhead light unit 88 and a table light unit 90 extending at least partially upward from the operating table 86. Here, each of the overhead and table light units 88, 90 includes one or more light sources 51 that selectively illuminate the surgical suite 8, direct light 19 toward the operating table 86, and/or direct light 19 toward the light directing device 16 of the intelligent head mirror 12. The light directing device 16 of the intelligent head mirror 12 routes light 19 provided by the plurality of light units 88, 90 toward the target area 44. As illustrated, the overhead and table light units 88, 90 include a fourth sensor 92 and a fifth sensor 94, respectively. The fourth and fifth sensors 92, 94 may include the functionality of one or more of the first, second, and third sensors 68, 69, 82. In alternative configurations, the overhead light unit 88 may omit the fourth sensor 92, and the table light unit 90 may omit the fifth sensor 94. In such configurations, each of the first, second, and third sensors 68, 69, 82 may be disposed on or within one of the overhead and table light units 88, 90. The plurality of light units 88, 90 may include one or more lighting assemblies described in the '140 patent and/or one or more lighting assemblies described in the '124 patent. According to some aspects, the plurality of light units 88, 90 may be movable and configured similar to the plurality of light assemblies or lighting modules described in the '140 patent or the plurality of light assemblies or lighting modules described in the '124 patent. In some instances, the plurality of light units 88, 90 may be movable in up to three dimensions, including in a vertical direction.

In some configurations of the intelligent lighting system 10, the overhead and table light units 88, 90 further include a second controller 96 and a third controller 98, respectively. The second and third controllers 96, 98 may be in wired or wireless communication with the first controller 66 provided by the intelligent head mirror 12 (FIG. 1). According to some aspects, the second controller 96 and/or the third controller 98 may have the functionality of or be similarly configured relative to the first controller 66. Furthermore, controller operations provided by the intelligent lighting system 10 may be allocated among more than one controller thereof. For example, the second controller 96 of the overhead light unit 88 may receive data from the first, second, and third sensors 68, 69, 82 (FIG. 1), determine the instant disposition of the light directing device 16, and wirelessly transmit data representing the instant disposition of the light directing device 16 to the first controller 66 of the intelligent head mirror 12. Here, the first controller 66 may determine the target disposition of the light directing device 16 and activate the electrical actuator 18 in response to determining that the instant disposition of the light directing device 16 is different than the target disposition of the light directing device 16. In another example, the second controller 96 and/or the third controller 98 may determine the instant disposition of the light directing device 16 and the target area 44. In response, the second controller 96 and/or the third controller 98 may prompt one or more of the plurality of light units 88, 90 to selectively direct light 19 toward the light directing device 16 from a position and/or orientation in which the one or more light units 88, 90 optimally illuminate the target area 44. This may require the second controller 96 and/or the third controller 98 to prompt one or more of the plurality of light units 88, 90 to move in up to three dimensions in addition to or instead of activating the electrical actuator 18 of the intelligent head mirror 12 and operating the light directing device 16 between dispositions. In such examples, the light directing device 16 may remain generally stationary. It is contemplated that the intelligent lighting system 10 may only include one or two of the first, second, and third controllers 66, 96, 98.

The intelligent head mirror 12 advantageously requires minimal electronics, support, and power to operate. As a result, the weight of the intelligent head mirror 12 is minimized, heat dissipation of the intelligent head mirror 12 is increased, and the intelligent head mirror 12 can operate without being tethered to an external power source. As the intelligent head mirror 12 is able to achieve a lighter profile, the user 22 may be kept more comfortable during longer operations. The intelligent head mirror 12 is especially advantageous for deep-cavity surgeries due to its lower power, low weight, and heat-dissipating features, enabling the user 22 to conveniently and comfortably illuminate the target area 44. Furthermore, as the intelligent head mirror 12 can operate untethered from an external power source, the user 22 can avoid cord tangling and cord-related mobility restraints.

It will be understood by one having ordinary skill in the art that construction of the described disclosure and other components is not limited to any specific material. Other exemplary embodiments of the disclosure disclosed herein may be formed from a wide variety of materials, unless described otherwise herein.

According to one aspect of the present disclosure, an intelligent head mirror includes a head strap, a first light directing device pivotally coupled to the head strap, wherein the first light directing device is configured to redirect light toward a focal point, and an electrical actuator operably coupled to the first light directing device, wherein the electrical actuator is configured to pivot the first light directing device relative to the head strap in at least two dimensions.

According to another aspect, the first light directing device includes a first reflective surface having a first parabolic curve opening away from the head strap.

According to still yet another aspect, the first reflective surface defines a center aperture.

According to another aspect, the intelligent head mirror further includes a second light directing device pivotally coupled to the head strap, wherein the second light directing device includes a second reflective surface having a second parabolic curve opening away from the head strap.

According to yet another aspect, the first and second light directing devices are laterally spaced along the head strap.

According to another aspect, the electrical actuator is in communication with a controller, wherein the controller is configured to control an angle of the first light directing device relative to the head strap via the electrical actuator.

According to still yet another aspect, at least one sensor is configured to measure the angle of the first light directing device relative to the head strap, wherein the controller is in communication with the at least one sensor.

According to another aspect, a battery pack is coupled to the head strap, wherein the battery pack is configured to power the electrical actuator.

According to yet another aspect of the present disclosure, an intelligent lighting system includes an intelligent head mirror having a head strap and a light directing device with a reflective surface, wherein the light directing device is coupled to the head strap, and wherein the light directing device is pivotal relative to the head strap in at least two dimensions. A sensor is disposed on the intelligent head mirror, wherein the sensor detects an instant disposition of the light directing device relative to a reference disposition, and a controller is in communication with the intelligent head mirror, wherein the controller receives instant disposition data from the sensor and controls an orientation of the light directing device relative to the head strap.

According to another aspect, the controller is disposed on the intelligent head mirror.

According to yet another aspect, the controller is configured to pivot the light directing device in response to a determination that the instant disposition of the light directing device relative to the head strap is not substantially equal to a target disposition of the light directing device relative to the head strap.

According to still yet another aspect, the controller defines a first controller, and wherein a second controller is in wireless communication with the first controller.

According to another aspect, at least one of the first and second controllers determines a target area to be illuminated, determines the instant disposition of the light directing device relative to the reference disposition, and determines the target disposition of the light directing device relative to the head strap, wherein the light directing device is configured to direct light toward the target area when in the target disposition.

According to another aspect, at least one of the first and second controllers determines a target area to be illuminated, determines the instant disposition of the light directing device relative to the reference disposition, and prompts one or more light units to selectively direct light toward the light directing device from a position and orientation in which the one or more light units optimally illuminate the target area.

According to another aspect, the intelligent lighting system further includes a light unit with one or more light sources, wherein the light unit contains the second controller.

According to yet another aspect, the intelligent head mirror includes a plurality of light directing devices, wherein each of the plurality of light directing devices operates independently to direct light toward the target area.

According to still yet another aspect, an intelligent head mirror includes a head strap, a first light directing device pivotally coupled to the head strap, wherein the first light directing device is configured to redirect light toward a focal point, an electrical actuator operably coupled to the first light directing device, wherein the electrical actuator is configured to pivot the first light directing device relative to the head strap, and a battery pack electrically coupled to the electrical actuator, wherein the battery pack is configured to power the electrical actuator.

According to yet another aspect, the battery pack is coupled to the head strap.

According to another aspect, the battery pack is electrically coupled to the electrical actuator via wiring.

According to yet another aspect, a second light directing device is pivotally coupled to the head strap, wherein the second light directing device is configured to redirect light toward a focal point.

According to still yet another aspect, a sensor is coupled to the head strap and is configured to measure an angle of the first light directing device relative to the head strap, and a controller is coupled to the head strap, wherein the controller is in communication with the electrical actuator and the sensor, and wherein the controller is configured to control the angle of the first light directing device relative to the head strap, via the electrical actuator, based on the angle of the first light directing device relative to the head strap as measured by the sensor.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure, as shown in the exemplary embodiments, are illustrative only. Although only a few embodiments of the present innovations have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. An intelligent head mirror, comprising:
a head strap;
a first light directing device pivotally coupled to the head strap, wherein the first light directing device is configured to redirect light toward a focal point; and
an electrical actuator operably coupled to the first light directing device, wherein the electrical actuator is configured to pivot the first light directing device relative to the head strap in at least two dimensions.

2. The intelligent head mirror of claim 1, wherein the first light directing device includes a first reflective surface having a first parabolic curve opening away from the head strap.

3. The intelligent head mirror of claim 2, wherein the first reflective surface defines a center aperture.

4. The intelligent head mirror of claim 2, further comprising:
a second light directing device pivotally coupled to the head strap, wherein the second light directing device includes a second reflective surface having a second parabolic curve opening away from the head strap.

5. The intelligent head mirror of claim 4, wherein the first and second light directing devices are laterally spaced along the head strap.

6. The intelligent head mirror of claim 1, wherein the electrical actuator is in communication with a controller, and wherein the controller is configured to control an angle of the first light directing device relative to the head strap via the electrical actuator.

7. The intelligent head mirror of claim 6, further comprising:
at least one sensor configured to measure the angle of the first light directing device relative to the head strap, wherein the controller is in communication with the at least one sensor.

8. The intelligent head mirror of claim 1, further comprising:
a battery pack coupled to the head strap, wherein the battery pack is configured to power the electrical actuator.

9. An intelligent lighting system, comprising:
an intelligent head mirror having a head strap and a light directing device with a reflective surface, wherein the light directing device is coupled to the head strap, and wherein the light directing device is pivotal relative to the head strap in at least two dimensions;
a sensor disposed on the intelligent head mirror, wherein the sensor detects an instant disposition of the light directing device relative to a reference disposition; and
a controller in communication with the intelligent head mirror, wherein the controller receives instant disposition data from the sensor and controls an orientation of the light directing device relative to the head strap.

10. The intelligent lighting system of claim 9, wherein the controller is disposed on the intelligent head mirror.

11. The intelligent lighting system of claim 9, wherein the controller is configured to pivot the light directing device in response to a determination that the instant disposition of the light directing device relative to the head strap is not substantially equal to a target disposition of the light directing device relative to the head strap.

12. The intelligent lighting system of claim 9, wherein the controller defines a first controller, and wherein a second controller is in wireless communication with the first controller.

13. The intelligent lighting system of claim 12, wherein at least one of the first and second controllers is configured to:
determine a target area to be illuminated;
determine the instant disposition of the light directing device relative to the reference disposition; and
determine a target disposition of the light directing device relative to the head strap, wherein the light directing device is configured to direct light toward the target area when in the target disposition.

14. The intelligent lighting system of claim 12, wherein at least one of the first and second controllers is configured to:
determine a target area to be illuminated;
determine the instant disposition of the light directing device relative to the reference disposition; and
prompt one or more light units to selectively direct light toward the light directing device from a position and orientation in which the one or more light units optimally illuminate the target area.

15. The intelligent lighting system of claim 13, wherein the intelligent head mirror includes a plurality of light directing devices, and wherein each of the plurality of light directing devices operates independently to direct light toward the target area.

16. An intelligent head mirror, comprising:
a head strap;
a first light directing device pivotally coupled to the head strap, wherein the first light directing device is configured to redirect light toward a focal point;
an electrical actuator operably coupled to the first light directing device, wherein the electrical actuator is configured to pivot the first light directing device relative to the head strap; and
a battery pack electrically coupled to the electrical actuator, wherein the battery pack is configured to power the electrical actuator.

17. The intelligent head mirror of claim 16, wherein the battery pack is coupled to the head strap.

18. The intelligent head mirror of claim 17, wherein the battery pack is electrically coupled to the electrical actuator via wiring.

19. The intelligent head mirror of claim 16, further comprising:
a second light directing device pivotally coupled to the head strap, wherein the second light directing device is configured to redirect light toward a focal point.

20. The intelligent head mirror of claim 16, further comprising:
a sensor coupled to the head strap and configured to measure an angle of the first light directing device relative to the head strap; and
a controller coupled to the head strap, wherein the controller is in communication with the electrical actuator and the sensor, and wherein the controller is configured to control the angle of the first light directing device relative to the head strap, via the electrical actuator, based on the angle of the first light directing device relative to the head strap as measured by the sensor.
